(19) United States
(12) Patent Application Publication
(10) Pub. No.: US 2003/0206236 A1
(43) Pub. Date: Nov. 6, 2003

(54) CMOS digital image sensor system and method

(75) Inventor: Vladimir Levantovsky, North Andover, MA (US)

Correspondence Address: AGFA CORPORATION, LAW & PATENT DEPARTMENT, 200 BALLARDVALE STREET, WILMINGTON, MA, 01887, US

(73) Assignee: Agfa Corporation, Wilmington, MA

(21) Appl. No.: 10/139,585

(22) Filed: May 6, 2002

(51) Int. Cl. H04N 3/14; H04N 5/335

(52) U.S. Cl. 348/310; 348/296; 348/308; 348/297

(57) ABSTRACT

An image sensor system comprises an array of pixels. Each of these pixels includes a light sensitive element that generates a pixel signal that is indicative of the amount of light received by that pixel. A comparator then compares the pixel signal to a reference signal and generates a strobe signal in response to this comparison, while a global counter generates a count across a shutter period. Finally, an array of memory elements is provided. Each of these memory elements stores a count from the global counter in response to receiving the strobe signal from the corresponding pixel of the array of pixels. As a result, the array of pixels has relatively little logic functionality. Each pixel need only contain the light sensitive element and the comparator. Thus, the system can provide a good fill factor. Further, the global counter can be shared across the entire memory array. It is most applicable to implementation in CMOS technology.

### BACKGROUND OF THE INVENTION

Charge coupled device (CCD) technology has been the platform of choice for manufacturing image sensors. CCD's having good dynamic range and high photon efficiency are commercially deployed in many types of systems from cameras to scanners.

The principle drawback associated with CCD technology, however, concerns the feasible level of integration. Logic is difficult to fabricate in CCD material systems. Thus, image sensors are typically multi-chip systems in which the CCD pixel array is integrated in a hybrid fashion with control logic, including memory and analog to digital converters. The control logic is fabricated in a platform that is more appropriate for logic. This is typically complimentary metal oxide semiconductor (CMOS) technology.

Recently, image sensor systems based entirely on CMOS technology have been entering the marketplace. Improvements in CMOS image sensor systems have yielded devices, which, although they do not have the sensitivity of CCD technology, have adequate sensitivity for many commercial applications.

The biggest push for the transition to entirely CMOS-based image sensors concerns the ability to integrate large amounts of logic functionality with the image sensor system, thereby avoiding the expense of hybrid integration. For example, in some designs, an analog-to-digital converter is associated with each pixel element in the pixel array. This would not be practical for CCD technology.

These new CMOS designs, however, must address a number of issues. One of the most important is dynamic range. Original scene conditions contain a large color gamut and a wide luminance dynamic range. The color rendering process is necessary to fit the encoding of captured images into the color gamut and dynamic range of the output media (e.g., computer monitors or printed pictures) and to apply appropriate tone and color reproduction aims. For example, in order to achieve a pleasing reproduction of the natural original scene conditions in the print media, it is sometimes necessary to increase relative contrast and color saturation of the image. Colorimetric reproduction of the original scene often produces images that are perceived to be flat and less colorful. Digital still cameras are capable of capturing colors that may be outside the color gamut of the output devices. Image capture in wide luminous dynamic range conditions, however, still represents a significant challenge. Even though some algorithms allow for the improvement in the rendering of high dynamic range scenes, they are not able to compensate for any loss of information in the original captured image. An example of a typical high dynamic range scene would be an object located in a room, back-lit by the sunlight coming from the window. An attempt to take a picture of the object in such conditions would result in a complete loss of either details in the scene outside the window in bright background or details of the object itself in the dark foreground. Image sensor systems should be capable of capturing the high dynamic range of the original scene, without loss of information.

### SUMMARY OF THE INVENTION

There are limits, however, in the level of integration that can be performed at the pixel element level, and the resulting tradeoffs can impact the dynamic range of the image sensor system. Adding more logic functionality into each pixel to increase dynamic range, for example, decreases the area of the pixel element that can be dedicated to the light sensitive element. One metric characterizing this relationship is called the “fill-factor”, which is the portion of the total area of the pixel element that is dedicated to its light sensitive element. As the fill-factor decreases, either sensitivity is sacrificed by making the light sensitive element smaller or the area of the pixel element is increased. Increasing the size of the pixel element, however, increases the size of the overall array for the same resolution and sensitivity. This results in a larger and more expensive chip, but more importantly larger optics are required in order to create a larger image for the larger pixel array. Larger optics dramatically affects the cost of the system since the optics is typically the most expensive component in an imaging system.

The present invention is directed toward an image sensor system. It allows for the minimization of the amount of logic in each pixel element to maximize fill factor, without sacrificing functionality. It is most applicable to implementation in CMOS technology.

In general, according to one aspect, the invention features an image sensor system. It comprises an array of pixels. Each of these pixels includes a light sensitive element that generates a pixel signal that is indicative of the amount of light received by that pixel. A comparator then compares the pixel signal to a reference signal and generates a strobe signal in response to this comparison, while a global counter generates a count across a shutter period. Finally, an array of memory elements is provided. Each of these memory elements stores a count from the global counter in response to receiving the strobe signal from the corresponding pixel of the array of pixels. As a result, the array of pixels has relatively little logic functionality. Each pixel need only contain the light sensitive element and the comparator. The global counter can be shared across the entire memory array.

In the preferred embodiment, each of the pixels further comprises a switch for charging a node of the light-sensitive element. In the present, CMOS implementation, the light-sensitive element comprises a photodiode that changes, discharges, a voltage of the node in response to received light. The switch charges a node in response to a reset signal.

According to one embodiment, the reference voltage signal provided by the reference voltage generator remains static during the period of light measurement. In the preferred embodiment, the reference voltage generator comprises a counter and digital to analog converter. As a result, it can ramp the reference voltage during the shutter period to limit the time of image capture and ensure the required shutter speed is maintained while still registering the light in a wide dynamic range. In the illustrated implementation, the reference voltage is ramped with an increasing, linear voltage.

In the preferred embodiment, the array of memory elements is located below the array of pixels on a chip of the sensor system. In this implementation, the strobe signals are transmitted from the array of pixels down to the array of memory elements.

In some implementations, it might be necessary and economically beneficial to reduce the number of lines that connect the pixel array to the memory array. In these examples, the strobe signals are transmitted on shared conductors by using a combination of row and column select signals.

In general, according to another aspect, the invention features a method of operation for an image sensor system. This method comprises detecting light with an array of pixels. Each of these pixels has a light sensitive element that generates a pixel signal indicative of an amount of light received by the corresponding pixel. Simultaneously, a count is generated, typically across the shutter period. Pixel signal levels are then compared to a reference signal level and a strobe is generated in response to the comparison, when both voltage levels are equal. The strobe signal is received by an array of memory elements. Each memory element stores a count from the counter in response to receiving the strobe signal from a corresponding pixel of the array of pixels.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A is a schematic view of an image sensor system according to the present invention;

FIG. 1B is a schematic view of an image sensor system according to another embodiment of the present invention;

FIG. 2 is a block diagram of a pixel in the image sensor system;

FIG. 3A is a timing diagram illustrating the operation of the image sensor system according to the present invention;

FIG. 3B is a timing diagram illustrating the operation of the image sensor system according to another embodiment of the present invention;

FIG. 4A is a perspective view showing the relationship between the array of pixels and the array of memory elements on a chip according to the present invention; and

FIG. 4B is a perspective view showing the relationship between the array of pixels and the array of memory elements on a chip according to another embodiment of the present invention.

### DETAILED DESCRIPTION OF THE PREFERRED EMBODIMENTS

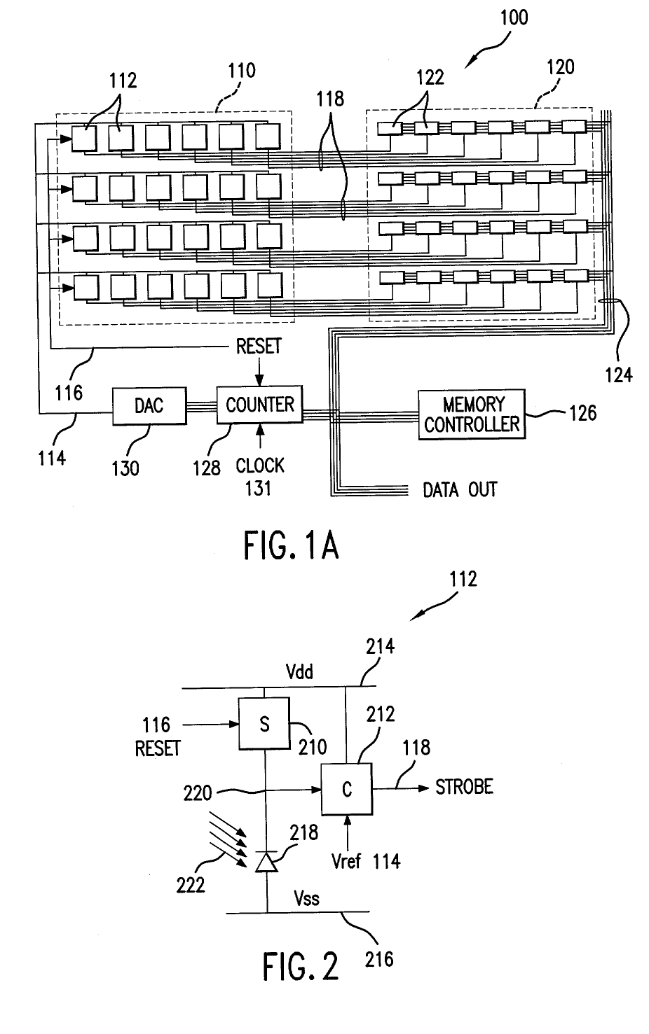

FIG. 1A shows an image sensor system 100, which has been constructed according to the principles of the present invention.

Specifically, the image sensor system 100 comprises an array of pixels 110. Each one of the pixels, receives, in addition to the operating voltages V_{dd} and Vₛₛ, a reset signal on line 116 and a reference voltage signal on line 114.

In response to the reset signal 116 and the reference voltage signal 114, each pixel 112 generates a separate strobe signal on lines 118. The strobe signals, on lines 118, are provided to an array of memory elements 120. The strobe signals from individual pixels 112 are received by corresponding memory elements 122 of the array of memory elements 120. That is, each pixel 112 has a dedicated memory element 122, such that there is a one-to-one relationship between the pixels 112 of the pixel array 110 and the memory elements 122 of the memory array 120.

Each memory element 122, in addition to its strobe signal 118, also receives signals broadcast on a bus 124. This bus 124 is used to upload data out of the memory array 120 during the active period of the reset signal 116 and provide control signals to the memory element array 120 that are issued by a memory controller 126. Most importantly, each of the memory elements 122 monitors a count broadcast in common to all of the memory elements 122 of the memory array 120 by a global counter 128.

In the preferred implementation, the global counter 128 generates an increasing count on bus 124 in response to a system clock signal 131 based on a trigger from the controller 126.

In one implementation, a reference voltage generator produces the reference signal on line 114 with a static, fixed voltage across a shutter period. In the preferred implementation, the reference voltage generator changes or ramps the reference signal across the shutter period. In one case, the ramp is linear, although exponential ramps are another possibility.

This reference ramp is achieved by generating the reference signal using a digital-to-analog converter (DAC) as the reference voltage generator 130. In the preferred implementation, this digital-to-analog converter is directly driven by the counter 128. In this way, the reference signal on line 114 changes in lock-step with the count broadcast on the bus 124 by the counter 128 in response to the clock 131.

FIG. 1B shows still another embodiment. In this example, transmission of the strobe signals between the pixel array 110 and the memory array 120 occurs on row select lines 512 and column select lines 510. These row/column connections enable selection of individual memory elements 122 in the memory array 120 by a strobe signal from the corresponding pixel 112. When a pixel is activated, it transmits a logic high strobe signal to the corresponding memory location 122 in the memory array 120 by driving its corresponding row and column line. In dependence on the strobe signal state, the corresponding memory location latches, or not, the count from counter 128.

The use of the row and column select signals enables shared strobe signal lines. The configuration reduces the number of traces required between the pixel array 110 and the memory array 120.

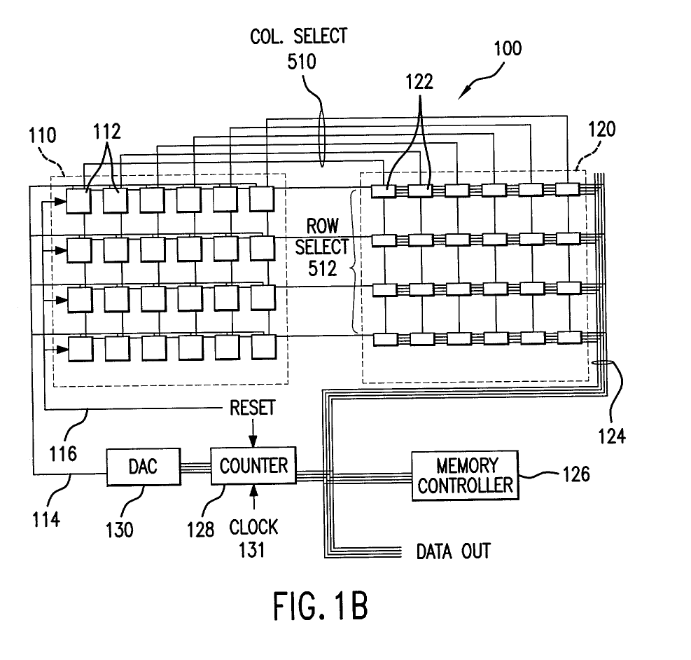

FIG. 2 shows an exemplary, typical pixel element 112 of the pixel array 110. Specifically, it comprises a light sensitive element 218. In the illustrated embodiment, it is a reversed-biased photodiode. During typical operation, in response to the reset signal on line 116, switch 210 closes intermittently to charge node 220 to the voltage V_{dd} from system voltage bus 214. The level of received light 222 controls the generation of carriers in the photodiode 218. The more light 222 that strikes the photodiode 218, the more charge bleeds off of node 220 to low voltage bus 216, carrying system voltage Vₛₛ.

Comparator 212 compares the pixel signal voltage at node 220 to the reference voltage provided on line 114. The comparator 112 generates the strobe signal on line 118 when the pixel signal voltage at node 220 falls below the reference voltage on line 114.

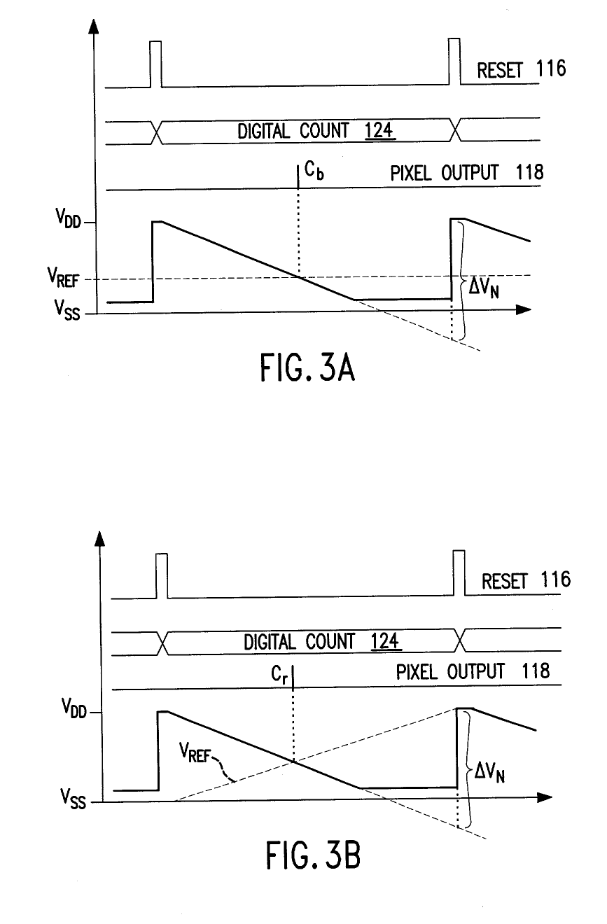

FIG. 3A is a timing diagram illustrating the operation of the image sensor system. Receipt of the reset signal 116 starts the shutter period. In addition to charging node 220 to V_{dd.} in each of the pixels, the reset signal 116 starts the global counter 128 and specifically the broadcast of the count on bus 124 to memory elements 122 of the memory array 120.

Based on the amount of light 222 that strikes the photodiode 218, the voltage on node 220 decreases, trending to the voltage level of the low voltage Vₛₛ on bus 216.

In the case where no digital to analog converter 130 is used and instead a static reference voltage is used, the voltage on node 220 passes below the reference voltage at time stamp C_{b}, which is related to the level of light 222. At this point, the strobe signal 118 is generated to the corresponding memory element 122 associated with the pixel. This causes the memory element 122 to latch the current count from the global counter 128 that is being broadcast on bus 124.

Assuming that the value V_{REF} is constant for the exposure time and the period of the reset pulses is equal to N clock periods, the normalized value of the pixel at the count value C=C_{b} is specified by the following equation:

V_{N}=(V_{dd}−V_{REF})*N/C

FIG. 3B is a timing diagram showing the use of the digital-to-analog converter reference voltage generator 130 enabling the limitation of the registration time, e.g. in reduced levels of illumination where long exposure time may cause increased image noise due to dark current, and/or assuring constant shutter speed, e.g. for video camera applications with predetermined video frame refresh rate. Specifically, in this example, the reference voltage is generated in the form of a linear ramp, V_{ref(ramp)}. The pixel signal voltage 220 passes below the reference voltage at time stamp Cᵣ. At this point, the strobe signal is generated on line 118 to latch the current count, generated by the counter 128, in the memory element 122.

In this example, if the DAC gain is set to (V_{dd}−V_{SS})/N to utilize the full available range, then V_{REF}=V_{SS}+(V_{dd}−V_{SS})*C/N and the normalized output pixel value at the count C=Cᵣ is specified by the following equation:

V_{N}=(V_{dd}−V_{SS})*(N/C−1)

Use of the time stamp C as a captured image value in both of the previous examples effectively increases the dynamic range or V_{N} beyond the voltage difference between the high voltage V_{dd} and the low system voltage Vₛₛ. Of note in this system is the fact that the complexity of each pixel element is relatively small. Generally, only a switch and a comparator are minimally needed in the pixel, in addition to the photodiode 218. However, analog-to-digital conversion is provided by using the shared global counter 128 that broadcasts its current count to all of the memory elements 122 in the memory array 120.

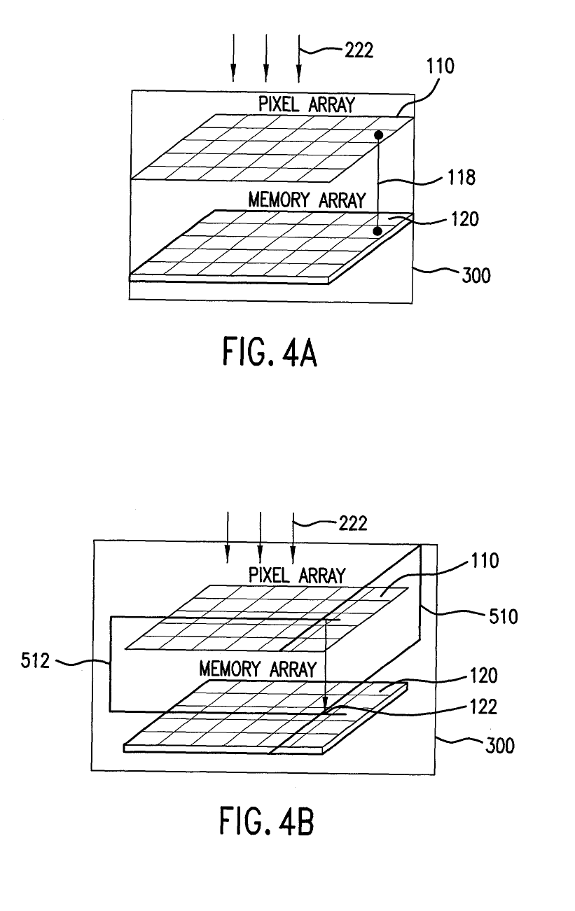

FIG. 4A shows a perspective view of one implementation of the image sensor system on a chip 300. Preferably, a multi-layer system is used in which the pixel array 110 occupies the top layer of the chip 300. The memory elements of the memory array 120 are fabricated below the pixel array 110. In this way, the pixel array 110 receives the incoming light 222. The strobe signals 118 are then transmitted down to the corresponding memory elements in the memory array 120. Note that the drawing shows only a single strobe line for clarity, in the embodiment there is a strobe line 118 between each pixel and corresponding memory element 122. This minimizes the total footprint of the system, thereby decreasing die size and thus the cost for each chip 300.

FIG. 4B shows a perspective view of still another embodiment of the image sensor system on a chip 300. In this example, access to the memory array 120 and pixel array 110 is controlled by row select signal 512 and column select signal 510. These signals enable selection of individual memory elements in the memory array 120. When a pixel is active, it transmits a strobe signal through both its row select line 512 and column select line 510 to the corresponding memory location 122 in the memory array 120, causing it to latch the global count. Note that the drawing shows only a single pair of column and row lines for clarity.

While this invention has been particularly shown and described with references to preferred embodiments thereof, it will be understood by those skilled in the art that various changes in form and details may be made therein without departing from the scope of the invention encompassed by the appended claims.

What is claimed is:

1. An image sensor system, comprising:
an array of pixels, each of the pixels including:
a light sensitive element that generates a pixel signal indicative of an amount of light received by the corresponding pixel, and
a comparator for comparing the pixel signal to a reference signal and generating a strobe signal in response to the comparison;
a reference voltage generator for generating the reference signal, which is distributed to the array of pixels;
a global counter which generates a count across a shutter period;
an array of memory elements, each memory element storing a count from the counter in response to receiving the strobe signal of a corresponding pixel of the array of pixels.

2. An image sensor system as claimed in claim 1, wherein each of the pixels further includes a switch for charging a node of the light sensitive element.

3. An image sensor system as claimed in claim 2, wherein the light sensitive element comprises a photodiode that changes a voltage of the node in response to received light.

4. An image sensor system as claimed in claim 2, wherein the switch charges the node in response to a reset signal.

5. An image sensor system as claimed in claim 1, wherein the reference voltage generator comprises a digital to analog converter.

6. An image sensor system as claimed in claim 1, wherein the reference voltage generator ramps the reference signal during the shutter period.

7. An image sensor system as claimed in claim 1, wherein the reference voltage generator generates the reference signal with a linear ramp.

8. An image sensor system as claimed in claim 1, wherein the array of memory elements is located below the array of pixels on a chip of the sensor system.

9. An image sensor system as claimed in claim 1, wherein the strobe signals are transmitted from the array of pixels to the array of memory elements.

10. An image sensor system as claimed in claim 1, further comprising select signals for accessing the array of pixels.

11. An image sensor system as claimed in claim 10, wherein the strobe signals are transmitted from the array of pixels to the array of memory elements on shared lines.

12. An image sensor system as claimed in claim 1, wherein the array of pixels is separate from the array of memory elements.

13. A method of operation of an image sensor system, the method comprising:
detecting light with an array of pixels, each having a light sensitive element that generates a pixel signal indicative of an amount of light received by the corresponding pixel, while initiating and broadcasting a count;
comparing pixel signals to a reference signal;
generating strobe signals in response to the comparison of the pixel signals and the reference signal;
receiving the strobe signals at an array of memory elements; and
each memory element storing the count in response to receiving the strobe signal of a corresponding pixel of the array of pixels.

14. A method as claimed in claim 13, further comprising charging a node of the light sensitive element prior to the step of detecting the light.

15. A method as claimed in claim 14, further comprised decreasing a voltage of the node with a photodiode.

16. A method as claimed in claim 13, further comprising generating the reference signal with a digital to analog converter.

17. A method as claimed in claim 13, further comprising ramping the reference voltage during a shutter period.

18. A method as claimed in claim 13, further comprising transmitting the strobe signals from the array of pixels to the array of memory elements.
